(19) United States
(12) Patent Application Publication
(10) Pub. No.: US 2026/0270978 A1
(43) Pub. Date: Sep. 10, 2026

(54) Method and user equipment for Radio Resource Management Scheduling

(71) Applicant: MEDIATEK INC., Hsinchu City (TW)

(72) Inventors: Kai-Tai Yang, Hsinchu City (TW); Mu-Ming Chiou, Hsinchu City (TW)

(73) Assignee: MEDIATEK INC., Hsinchu City (TW)

(21) Appl. No.: 19/548,985

(22) Filed: Feb. 25, 2026

Related U.S. Application Data
(60) Provisional application No. 63/767,022, filed on Mar. 5, 2025.

(51) Int. Cl. H04W 72/12; H04W 24/10; H04W 56/00; H04W 72/51

(52) U.S. Cl. CPC H04W 72/12; H04W 24/10; H04W 56/0015; H04W 72/51

(57) ABSTRACT

A method and user equipment (UE) for enhanced Radio Resource Management (RRM) scheduling are provided. The method comprises detecting, by an application processor (AP) of the UE, a motion context of the UE based on sensor data obtained by the application processor. The motion context may indicate, for example, movement limited to a confined geographic area. The application processor generates an indicator corresponding to the motion context and transmits the indicator to a modem of the UE. Upon receiving the indicator, the modem adjusts an RRM scheduling behavior of the UE. The adjustment may include reducing a frequency of cell measurement operations or setting a speed dependent scaling factor to unity, thereby conserving power in scenarios where aggressive measurement is unnecessary despite physical movement of the UE.

### CROSS REFERENCE TO RELATED APPLICATIONS

This application claims the benefit of U.S. Provisional Application No. 63/767,022, filed on Mar. 5, 2025. The content of the application is incorporated herein by reference.

### BACKGROUND

In modern wireless communication networks, such as those defined by 3GPP specifications, a user equipment (UE) is required to perform various measurement activities to ensure continuous connectivity. These activities include Cell Search (CS) and Cell Measurement (CM) to identify suitable cells for potential handover.

Typically, the frequency and aggressiveness of these measurements depend on the mobility state of the UE. When a UE is in a moving state (e.g., traveling in a vehicle), the RRM behavior is designed to be conservative and frequent. For instance, 3GPP specifications mandate that if a UE detects movement, which is often determined by variations in signal strength or successful cell reselections, it must perform measurements more frequently to find the next cell quickly and avoid radio link failure.

However, this conventional approach can be inefficient in certain “confined” mobility scenarios, such as a user exercising in a gymnasium, walking within an office, or moving inside a home. In these scenarios, the UE is physically moving, which generates speed and signal variation that a modem may interpret as a High-mobility or Medium-mobility state. Consequently, the modem may trigger aggressive measurement schedules (e.g., speed dependent scaling) designed for highway travel, even though the UE remains within the coverage of a single cell or a small cluster of cells.

Standard modems generally estimate mobility changes through Radio Frequency (RF) signal variations, e.g., Doppler shift or Reference Signal Received Power (RSRP). They typically lack access to contextual sensor data (e.g., accelerometers or GPS) that could differentiate between “confined” movement and “transit” movement. As a result, the UE performs unnecessary measurements, leading to significant and avoidable power consumption.

Therefore, there is a need for an improved RRM scheduling mechanism that leverages the collaboration between the application processor (AP) and the modem to contextually identify these semi-static scenarios and optimize power usage accordingly.

### SUMMARY

An embodiment provides a method for Radio Resource Management (RRM) scheduling in a user equipment (UE). The method comprises detecting, by an application processor of the UE, a motion context of the UE based on sensor data obtained by the application processor. The method further comprises generating, by the application processor, an indicator corresponding to the motion context and transmitting the indicator to a modem of the UE. The method also includes receiving, by the modem, the indicator from the application processor, and adjusting, by the modem, RRM scheduling of the UE in response to the indicator.

In some embodiments, the motion context indicates a movement of the UE limited to a confined geographic area. Adjusting the RRM scheduling may comprise reducing a frequency of a cell measurement operation relative to a high-mobility state or a medium-mobility state, adjusting a frequency of a cell measurement operation equivalent to a default state, or adjusting a speed dependent scaling to unity. The sensor data may be obtained from at least one of an accelerometer, a gyroscope, a Global Navigation Satellite System (GNSS) receiver, and a camera of the UE. Additionally, adjusting the RRM scheduling may comprise reducing a frequency of processing Synchronization Signal Blocks (SSB) received from neighboring cells. The method may further comprise detecting, by the application processor, that the UE has exited the motion context; transmitting a second indicator to the modem; and reverting, by the modem, the RRM scheduling to a default measurement configuration defined by a network parameter in response to the second indicator.

Another embodiment of the present invention provides a user equipment (UE). The UE comprises a modem configured to perform RRM operations and an application processor coupled to the modem. The application processor is used to detect a motion context of the UE based on sensor data and generate an indicator corresponding to the motion context. The modem is used to receive the indicator from the application processor and adjust an RRM scheduling of the UE in response to the indicator.

To the accomplishment of the foregoing and related ends, certain embodiments comprise the features hereinafter fully described and particularly pointed out in the claims. The following description and accompanying drawings set forth in detail certain illustrative aspects of the embodiments. These aspects are indicative, however, of but a few of the various ways in which the principles of the embodiments may be employed, and the present disclosure is intended to include all such aspects and their equivalents. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a diagram illustrating an exemplary wireless communications system and access network.

FIG. 2 depicts a block diagram illustrating a base station in communication with a user equipment (UE) in a wireless network.

FIG. 3 depicts a flow diagram illustrating a standard Radio Resource Management (RRM) scheduling process performed by a UE.

FIG. 4 depicts a state transition diagram illustrating the management of RRM scheduling states within the UE according to an embodiment of the present disclosure.

FIG. 5 depicts a flow diagram illustrating a method for RRM scheduling in a UE according to an embodiment of the present disclosure.

### DETAILED DESCRIPTION

The present invention relates to Radio Resource Management (RRM) scheduling in the context of 3rd Generation Partnership Project (3GPP) based mobile communication systems, including Fourth Generation Long-Term Evolution (4G LTE), Fifth Generation New Radio (5G NR), and beyond. While the embodiments described herein primarily focus on 3GPP wireless networks, the disclosed techniques may be applied to various wireless multiple access systems. Such systems can include Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), and Multi-Carrier Frequency Division Multiple Access (MC-FDMA) systems.

In 3GPP specifications, user equipment (UE) mobility management relies on RRM measurements and cell reselection procedures to maintain continuous network connectivity. These specifications define mobility state detection mechanisms based on the number of cell reselections within a predefined time window (T_{CRmax}). When a UE experiences frequent cell reselections exceeding specified thresholds (N_{CR_M} for Medium mobility and N_{CR_H} for High mobility), the specifications mandate that the UE enter a Medium-mobility or High-mobility state and apply speed dependent scaling to various RRM parameters. Specifically, the cell reselection timer (Treselection_{RAT}) is scaled by factors such as sf-Medium (e.g., 0.5) or sf-High (e.g., 0.25). This adjustment results in more aggressive and frequent cell measurements and reselections.

While this standards-defined approach effectively maintains connectivity for UEs in genuine high-mobility scenarios such as vehicular travel across multiple cell coverage areas, it can lead to significant inefficiencies in certain real-world usage patterns. The conventional RRM scheduling mechanisms defined in 3GPP specifications rely exclusively on Radio Frequency (RF) layer observations—primarily cell reselection counts and signal quality variations—to infer mobility state. These mechanisms lack access to higher-layer contextual information that could differentiate between a UE experiencing true inter-cell mobility (e.g., a user traveling on a highway) and a UE experiencing confined movement within a single cell or small cluster of cells (e.g., a user exercising in a gymnasium or walking within an office building).

The present disclosure addresses this limitation by introducing a cross-layer optimization mechanism that augments the standard 3GPP RRM procedures with application processor-derived motion context information. By leveraging sensor data available to the application processor—including but not limited to accelerometer readings, gyroscope data, Global Navigation Satellite System (GNSS) position information, and other environmental sensors—the disclosed system can identify confined movement scenarios where the standard mobility state detection would otherwise trigger unnecessary aggressive RRM behavior. When such a scenario is detected, the application processor communicates with the modem to adjust the RRM scheduling, effectively overriding or modifying the speed dependent scaling behavior that would normally be mandated by the 3GPP specifications for a detected Medium-mobility or High-mobility state.

Importantly, the disclosed method and apparatus operates as an enhancement to, rather than a replacement of, the standard 3GPP RRM procedures. The modem continues to comply with all mandatory 3GPP requirements for cell search, cell measurement, and cell reselection. However, by utilizing the additional contextual information provided by the application processor, the modem can intelligently adapt its measurement frequency and aggressiveness to the actual physical circumstances of the UE, thereby achieving substantial power savings without compromising the reliability and performance guarantees required by the 3GPP specifications. In scenarios where radio conditions deteriorate or where the confined movement context is no longer applicable, the system seamlessly reverts to the standard 3GPP-defined RRM behavior, ensuring robust connectivity management under all circumstances.

The following detailed description presents various embodiments of the invention with reference to the accompanying figures. These embodiments illustrate how the disclosed techniques can be implemented within the framework of 3GPP-compliant UEs and wireless communication systems, providing enhanced power efficiency while maintaining full compatibility with existing network infrastructure and specifications.

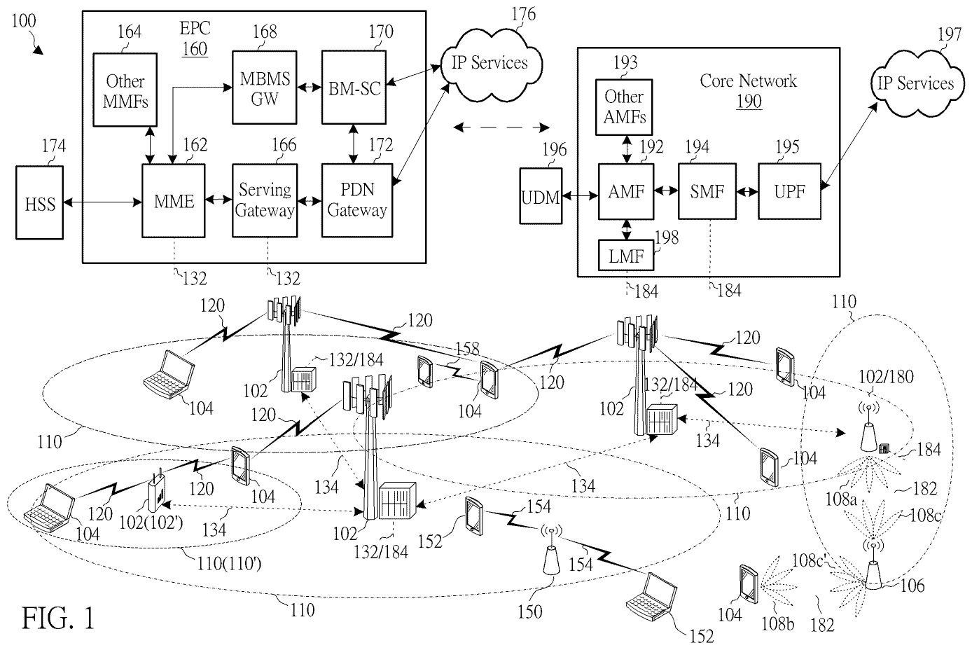

FIG. 1 depicts an exemplary wireless communications system and access network 100. The wireless communication system (also referred to as a wireless wide area network (WWAN)) includes base stations 102, UEs 104, an Evolved Packet Core (EPC) 160, and an additional core network 190 (such as a 5G Core (5GC), IoT network and 6G communication system). The base stations 102 can be macrocells (high-power cellular base stations) or small cells (low-power cellular base stations). Macrocells refer to large-scale base stations, while small cells include femtocells, picocells, and microcells.

The base stations 102 designed for 4G LTE operation (collectively known as Evolved Universal Mobile Telecommunications System (UMTS) Terrestrial Radio Access Network (E-UTRAN)) may connect to the EPC 160 via backhaul links 132 (e.g., S1 interface). Similarly, base stations 102 configured for 5G NR (collectively designated as Next Generation RAN (NG-RAN)) can interface with core network 190 through backhaul links 184. The base stations 102 may be also designed as network nodes for 6G network. These base stations can perform numerous functions beyond basic connectivity, which may include: user data transfer, radio channel encryption and decryption, integrity protection, header compression, mobility management (e.g., handover, dual connectivity), interference coordination between cells, connection management, load distribution, handling of non-access stratum (NAS) messages, NAS node selection, network synchronization, RAN resource sharing, multimedia broadcast services (MBMS), subscriber tracking, RAN information management (RIM), paging services, position determination, and emergency alert distribution. Additionally, base stations 102 may communicate with each other either directly or indirectly (e.g., through the EPC 160 or core network 190) using backhaul links 134 (e.g., X2 interface), which can be implemented as either wired or wireless connections.

The base stations 102 may wirelessly communicate with the UEs 104. Each base station 102 can provide coverage for a specific geographic area 110, and there may be overlapping coverage areas 110. For instance, the small cell 102′ may have a coverage area 110′ that overlaps with the coverage area 110 of one or more macro base stations 102. A network that includes both small cells and macrocells may be referred to as a heterogeneous network. This type of network may also include Home Evolved Node Bs (HeNBs), which can serve a restricted group known as a closed subscriber group (CSG). The communication links 120 between the base stations 102 and the UEs 104 may involve uplink (UL) (also known as reverse link) transmissions from a UE 104 to a base station 102 and/or downlink (DL) (also known as forward link) transmissions from a base station 102 to a UE 104.

The communication links 120 may use multiple-input and multiple-output (MIMO) antenna technology, including spatial multiplexing, beamforming, and/or transmit diversity. The communication links may be through one or more carriers. For each carrier, the base stations 102 and/or UEs 104 may utilize spectrum with bandwidths of various sizes (e.g., 5, 10, 15, 20, 100, 400, etc. MHz) up to 7 MHz per carrier. Through carrier aggregation, these individual carriers can be combined to achieve a total bandwidth of Y×X MHz, where X represents the number of component carriers, enabling higher data rates for transmission in each direction. The carriers may or may not be adjacent to one another. The allocation of carriers can be asymmetric with respect to DL and UL, meaning that more or fewer carriers may be allocated for DL than for UL. The component carriers may include a primary component carrier and one or more secondary component carriers. A primary component carrier may be referred to as a primary cell (PCell), while a secondary component carrier can be referred to as a secondary cell (SCell).

Certain UEs 104 may communicate with each other using a device-to-device (D2D) communication link 158. This D2D communication link 158 can utilize the DL/UL WWAN spectrum and may operate on one or more sidelink channels, such as the physical sidelink broadcast channel (PSBCH), physical sidelink discovery channel (PSDCH), physical sidelink shared channel (PSSCH), and physical sidelink control channel (PSCCH). D2D communication can occur through various wireless D2D communication systems, including, for example, FlashLinQ, WiMedia, Bluetooth, ZigBee, Wi-Fi based on the IEEE 802.11 standard, LTE, or NR.

The wireless communications system may also include a Wi-Fi access point (AP) 150, which communicates with Wi-Fi stations (STAs) 152 via communication links 154 in the 5 GHz unlicensed frequency spectrum. When operating in an unlicensed frequency spectrum, the STAs 152 and AP 150 may perform a clear channel assessment (CCA) before communicating to check if the channel is available.

The small cell 102′ may operate in either licensed or unlicensed frequency spectrums, or both. When using an unlicensed frequency spectrum, the small cell 102′ can employ NR and utilize the same 5 GHz unlicensed frequency spectrum as the Wi-Fi AP 150. By employing NR in an unlicensed frequency spectrum, the small cell 102′ may enhance coverage and/or increase capacity of the access network.

A base station 102, which may be a small cell 102′ or a large cell (e.g., macro base station), can include an eNB, gNodeB (gNB), or another type of base station. Some base stations, such as gNB 180, may operate in a traditional sub 6 GHz spectrum, in millimeter wave (mmWave) frequencies, and/or near mmWave frequencies when communicating with the UE 104. When the gNB 180 operates in mmWave or near mmWave frequencies, it can be referred to as an mmWave base station.

Extremely high frequency (EHF) is part of the RF in the electromagnetic spectrum. EHF has a range of 30 GHz to 300 GHz and a wavelength between 1 millimeter and 10 millimeters. Radio waves in this band may be referred to as millimeter waves. Near mmWave may extend down to a frequency of 3 GHz with a wavelength of 100 millimeters. The super high frequency (SHF) band extends between 3 GHz and 30 GHz, also referred to as centimeter wave.

Communications using the mmWave and/or near mmWave radio frequency band (e.g., 3 GHz-300 GHz) can experience extremely high path loss and have a short range. The mmWave base station 180 may utilize beamforming 182 with the UE 104 to compensate for these limitations.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions 108c. The base station 180 may receive the beamformed signal from the UE 104 in one or more receive directions 108c′. This bidirectional beamforming capability is essential for establishing reliable mmWave communications. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 can communicate with a Home Subscriber Server (HSS) 174. The MME 162 is the control node that processes signaling between the UEs 104 and the EPC 160. Generally, the MME 162 provides bearer and connection management.

All user Internet protocol (IP) packets may transfer through the Serving Gateway 166, which itself connects to the PDN Gateway 172. The PDN Gateway 172 can provide UE IP address allocation as well as other functions. The PDN Gateway 172 and the BM-SC 170 may connect to the IP Services 176. The IP Services 176 can include the Internet, an intranet, an IP Multimedia Subsystem (IMS), a PS Streaming Service, and/or other IP services.

The BM-SC 170 may provide functions for MBMS user service provisioning and delivery. The BM-SC 170 can serve as an entry point for content provider MBMS transmission, may be used to authorize and initiate MBMS Bearer Services within a public land mobile network (PLMN), and can be used to schedule MBMS transmissions. The MBMS Gateway 168 may distribute MBMS traffic to the base stations 102 belonging to a Multicast Broadcast Single Frequency Network (MBSFN) area broadcasting a particular service, and can be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 can communicate with a Unified Data Management (UDM) 196. The AMF 192 is the control node that processes signaling between the UEs 104 and the core network 190. Generally, the SMF 194 may provide QoS flow and session management. The UPF 195 can serve as the pathway for all user IP packets. In addition to providing UE IP address allocation, the UPF 195 may perform various other functions. Connectivity between the UPF 195 and IP Services 197 is possible. The IP Services 197 may include the Internet, an intranet, an IP Multimedia Subsystem (IMS), a PS Streaming Service, and potentially additional IP services.

The base station may also be known as a gNB, Node B, eNB, an access point, a base transceiver station, a radio base station, a radio transceiver, a transceiver function, a basic service set (BSS), an extended service set (ESS), a transmit reception point (TRP), or other suitable terminology. The base station 102 can function as an access point to the EPC 160 or core network 190 for a UE 104.

Although this document discusses 5G NR technology, the concepts presented are also relevant to various other wireless communication standards and technologies. These include 6G, 5G NR, 4G LTE, LTE-A, CDMA, GSM, and may extend to future generations of wireless and radio access technologies that will evolve from current standards.

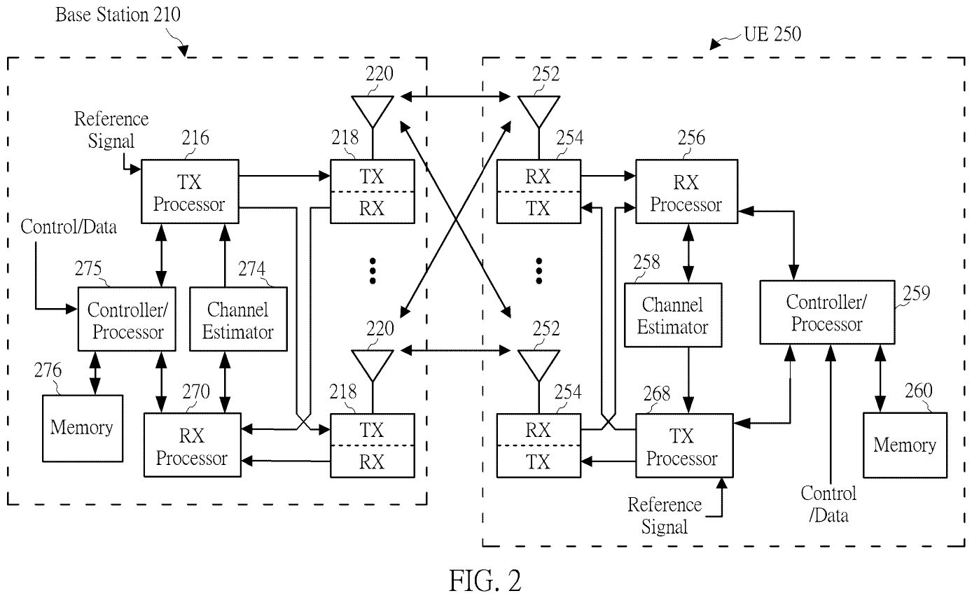

FIG. 2 depicts block diagrams of a base station 210 in communication with a UE 250 in a wireless network. In the DL, IP packets from the EPC 160 may be provided to a controller/processor 275. The controller/processor 275 can implement layer 3 and layer 2 functionality. Layer 3 includes a radio resource control (RRC) layer, and layer 2 may include a packet data convergence protocol (PDCP) layer, a radio link control (RLC) layer, and a medium access control (MAC) layer.

The controller/processor 275 can manage RRC layer functions related to broadcasting system information (e.g., MIB, SIBs), RRC connection control (e.g., RRC connection paging, establishment, modification, and release), radio access technology (RAT) mobility, and the configuration of measurements for UE measurement reporting. The controller/processor 275 may also handle PDCP layer functions related to header compression/decompression, security (including ciphering, deciphering, integrity protection, and integrity verification), and handover support; RLC layer functions for transferring upper layer packet data units (PDUs), error correction through ARQ, concatenation, segmentation, and reassembly of RLC service data units (SDUs), re-segmentation of RLC data PDUs, and reordering of RLC data PDUs; and MAC layer functions that include mapping logical channels to transport channels, multiplexing MAC SDUs onto transport blocks (TBs), demultiplexing MAC SDUs from TBs, reporting scheduling information, error correction through HARQ, priority handling, and logical channel prioritization.

The transmit (TX) processor 216 and the receive (RX) processor 270 may perform layer 1 functions related to various signal processing tasks. Layer 1, which includes the physical (PHY) layer, involves error detection on transport channels, forward error correction (FEC) coding/decoding of transport channels, interleaving, rate matching, mapping onto physical channels, modulation/demodulation of physical channels, and MIMO antenna processing.

The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then divided into parallel streams. Each stream is mapped to an OFDM subcarrier, multiplexed with a reference signal (e.g., pilot) in the time and/or frequency domain, and then combined using an Inverse Fast Fourier Transform (IFFT) to produce a physical channel carrying a time-domain OFDM symbol stream.

The OFDM stream can be spatially precoded to generate multiple spatial streams. Channel estimates from a channel estimator 274 help determine the coding and modulation scheme, as well as assist in spatial processing. These estimates are derived from a reference signal and/or feedback on channel conditions transmitted by the UE 250. Each spatial stream is sent to a different antenna 220 via a separate transmitter 218TX. Each transmitter 218TX modulates an RF carrier with its respective spatial stream for transmission.

At the UE 250, each receiver 254RX receives a signal through its respective antenna 252. The receiver 254RX recovers the information modulated onto the RF carrier and passes it to the RX processor 256. The TX processor 268 and RX processor 256 handle layer 1 functionality associated with various signal processing tasks. The RX processor 256 performs spatial processing on the received information to recover any spatial streams intended for the UE 250. If multiple spatial streams are directed to the UE 250, the RX processor 256 combines them into a single OFDM symbol stream. The RX processor 256 then converts the time-domain OFDM symbol stream into the frequency domain using a Fast Fourier Transform (FFT). The frequency-domain signal consists of a separate OFDM symbol stream for each subcarrier of the OFDM signal.

The symbols on each subcarrier, and the reference signal, can be recovered and demodulated by determining the most likely signal constellation points transmitted by the base station 210. These soft decisions may be based on channel estimates computed by the channel estimator 258. The soft decisions can then be decoded and deinterleaved to recover the data and control signals that were originally transmitted by the base station 210 on the physical channel. The data and control signals may then be provided to the controller/processor 259, which implements layer 3 and layer 2 functionality.

The controller/processor 259 may be linked to a memory 260 that holds program code and data, with the memory 260 often referred to as a computer-readable medium. In the UL, the controller/processor 259 handles tasks such as demultiplexing between transport and logical channels, packet reassembly, deciphering, header decompression, and control signal processing to recover IP packets from the EPC 160. Additionally, the controller/processor 259 is responsible for error detection through an ACK and/or NACK protocol to support HARQ operations.

Similar to the DL transmission functionality provided by the base station 210, the controller/processor 259 handles RRC layer functions related to system information (e.g., MIB, SIBs) acquisition, RRC connections, and measurement reporting; PDCP layer functions for header compression/decompression and security (including ciphering, deciphering, integrity protection, and integrity verification); RLC layer functions for transferring upper layer PDUs, error correction through ARQ, concatenation, segmentation, and reassembly of RLC SDUs, re-segmentation of RLC data PDUs, and reordering of RLC data PDUs; and MAC layer functions that include mapping logical channels to transport channels, multiplexing MAC SDUs onto TBs, demultiplexing MAC SDUs from TBs, scheduling information reporting, error correction through HARQ, priority handling, and logical channel prioritization.

Channel estimates derived by a channel estimator 258 from a reference signal or feedback transmitted by the base station 210 may assist the TX processor 268 in selecting the appropriate coding and modulation schemes, and in facilitating spatial processing. The spatial streams generated by the TX processor 268 can be transmitted to different antennas 252 via separate transmitters 254TX, with each transmitter modulating an RF carrier with its respective spatial stream. The UL transmission is processed at the base station 210 in a similar manner to the receiver function at the UE 250, where each receiver 218RX receives a signal through its respective antenna 220, recovers the modulated information, and sends it to a RX processor 270.

The controller/processor 275 may be linked to a memory 276 that stores program codes and data, with the memory 276 typically referred to as a computer-readable medium. In the UL, the controller/processor 275 manages demultiplexing between transport and logical channels, packet reassembly, deciphering, header decompression, and control signal processing to recover IP packets from the UE 250. These IP packets are then forwarded to the EPC 160. The controller/processor 275 is also responsible for error detection using an ACK and/or NACK protocol to support HARQ operations.

New Radio (NR) may refer to radios designed to operate on a new air interface (different from OFDMA-based interfaces) or a fixed transport layer (other than IP). NR may use OFDM with a cyclic prefix (CP) on both the UL and DL, and supports half-duplex operation using time division duplexing (TDD). NR may include services like Enhanced Mobile Broadband (eMBB) targeting wide bandwidth (e.g., 80 MHz or more), mmWave for high carrier frequencies (e.g., 60 GHz), massive Machine-Type Communications (mMTC) for non-backward compatible MTC techniques, and/or mission-critical communications targeting ultra-reliable low latency communications (URLLC).

The NR RAN may include a central unit (CU) and distributed units (DUs). A NR BS (e.g., gNB, 5G Node B, Node B, transmission reception point (TRP), access point (AP)) can correspond to one or multiple BSs.

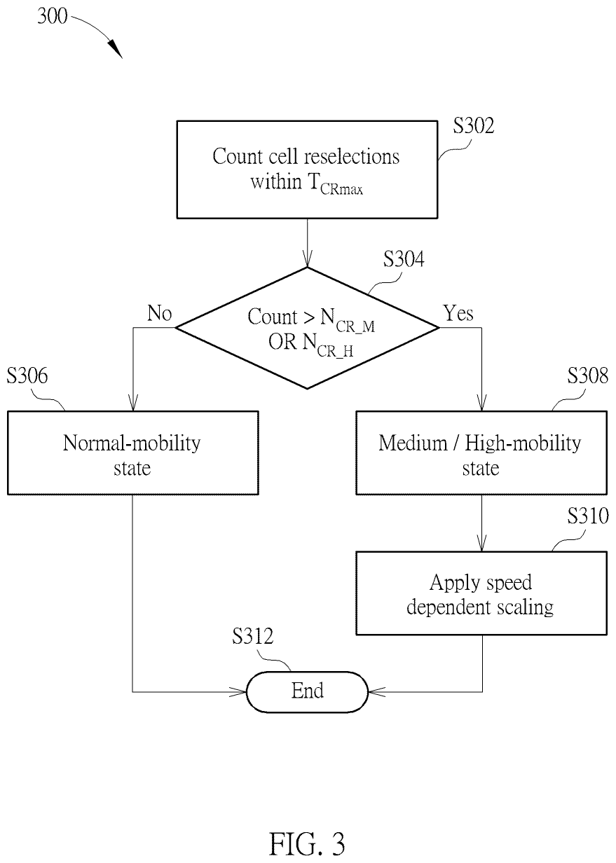

FIG. 3 depicts a flow diagram illustrating a normal (or standard) Radio Resource Management (RRM) scheduling process 300 performed by a UE (e.g. UE 250). This process determines how frequently the UE performs cell measurements and reselections based on its mobility history. The process begins at step S302, where the UE counts a number of cell reselections (or handovers) that have occurred within a predefined sliding time window (T_{CRmax})

In step S304, the UE compares this count against configured thresholds to determine its mobility state. Specifically, the UE determines if the number of cell reselections exceeds a medium threshold (N_{CR_M}) or a high threshold (N_{CR_H}). If the count is below these thresholds, the UE is considered to be in a Normal-mobility state (step S306), and no scaling is applied to the RRM parameters.

It should be noted that normal RRM scheduling refers to the standard 3GPP procedure for mobility management, which manages that a UE operates in a Normal-mobility state (where no scaling is applied) until cell reselection counts exceed a specific threshold. In other words, normal RRM scheduling refers to the comprehensive standard procedure defined by 3GPP for managing mobility states (including High, Medium, and Normal), whereas Normal-mobility state is a specific condition within that procedure that occurs when the number of cell reselections falls below a configured threshold.

However, if the count exceeds the thresholds, the UE enters a Medium-mobility state or High-mobility state (step S308). In these states, the 3GPP specifications mandate speed dependent scaling. Consequently, in step S310, the UE applies scaling factors to its RRM parameters. For example, the reselection timer (Treselection) is multiplied by a scaling factor less than 1 (e.g., 0.25 or 0.5), effectively forcing the UE to measure and reselect cells more aggressively (i.e., more frequently). The process concludes at step S312.

A limitation of the process 300 shown in FIG. 3 is its reliance solely on RF-based cell transition counts. It does not account for the physical context of the movement. As described in the Background, a user exercising in a confined area (e.g., a gym) may trigger frequent cell reselections due to signal fluctuations, causing the UE to falsely enter the High-mobility state (step S308) and apply aggressive scaling (step S310). This results in high power consumption despite the user remaining in a confined geographic area. The embodiments of the present invention, described subsequently, address this inefficiency by introducing an application-layer context check to override this standard behavior.

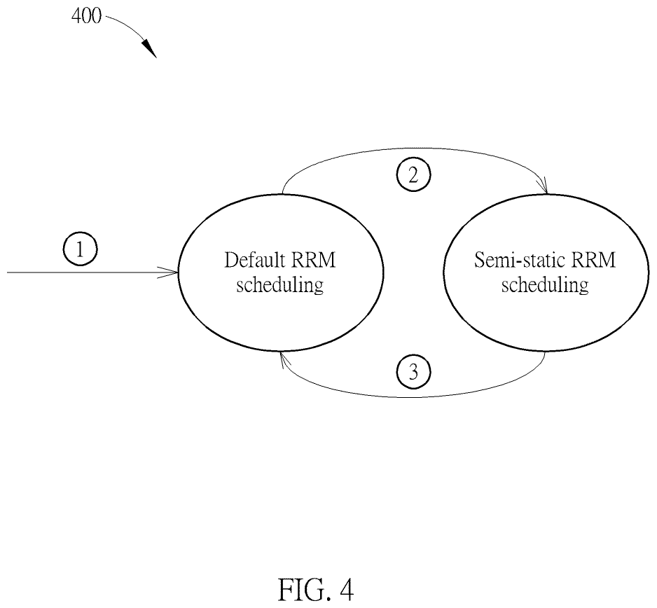

FIG. 4 depicts a state transition diagram 400 illustrating the management of RRM scheduling states within the UE according to an embodiment. The diagram specifically focuses on the interaction between a default (or normal) RRM scheduling state and a semi-static RRM scheduling state. As shown by the initial transition (1), the UE proceeds to the default RRM scheduling state upon initialization or when no specific motion context is detected. In this state, the modem operates in accordance with standard network specifications. Consequently, if the modem detects variations in signal strength or frequent cell reselections (as illustrated in FIG. 3), it will categorize the UE as being in a high-mobility or medium-mobility state and automatically apply aggressive RRM measures, such as speed dependent scaling, to ensure connectivity.

The transition (2) represents the activation of the inventive power-saving mechanism. This transition is triggered when the application processor (AP) detects a specific motion context based on sensor data (e.g., from an accelerometer, gyroscope, or GNSS). If the AP determines that the UE is moving but confined to a limited geographic area—such as a user exercising in a gym or walking within an office—it generates an indicator and transmits this indicator to the modem. Upon receipt, the modem transitions the UE to the semi-static RRM scheduling state. In this state, the modem overrides the standard mobility estimation logic defined by the default RRM scheduling. Even if RF signals fluctuate due to physical movement, the modem adjusts RRM behavior to mimic a stationary or low-mobility device. This adjustment may include setting speed dependent scaling factors to unity (effectively disabling “faster reselection”) or increasing the time interval between measuring neighboring cells, thereby significantly reducing power consumption during confined movement.

The transition (3) represents the reversion to standard operation. This transition typically occurs when the AP detects via sensor data that the UE has exited the confined motion context (e.g., the user has left the building and is traveling in a vehicle). In response, the AP transmits a second indicator (or de-asserts the previous indicator), prompting the modem to return to the Default RRM scheduling state. Additionally, in certain embodiments, this return transition may be triggered autonomously by the modem if the Signal-to-Noise Ratio (SNR) of the serving cell falls below a critical threshold, ensuring that connection reliability takes precedence over power saving when the radio environment deteriorates.

To accurately determine the motion context of the UE, the AP may be communicatively coupled to one or more sensors integrated within or accessible to the UE. In various embodiments, these sensors may include, but are not limited to, an accelerometer (e.g., a 3-axis accelerometer), a gyroscope, a magnetometer, a Global Navigation Satellite System (GNSS) receiver (e.g., GPS, GLONASS, Galileo, or BeiDou), a barometer, and/or a camera. Unlike the modem, which typically perceives motion only through indirect Radio Frequency (RF) metrics such as Doppler shift or Reference Signal Received Power (RSRP) fluctuations, the AP utilizes these sensors to acquire direct physical data regarding the UE's movement patterns and geographic displacement.

In one exemplary embodiment utilizing GNSS data, the application processor may distinguish between a “transit” scenario (e.g., driving on a highway) and a “confined” scenario (e.g., exercising in a gym or walking in an office) by analyzing the UE's geographic displacement over time. For instance, the modem might detect significant signal variations suggesting high mobility. However, the AP may monitor the GNSS coordinates and determine that the UE's net displacement over a predetermined time window is negligible or remains within a predefined geofence (e.g., a radius of 50 meters). If the sensor data indicates that the UE is physically active (e.g., high instantaneous velocity or acceleration) but geographically stationary or confined to a small area, the AP identifies the motion context as a confined geographic area, implying that the UE is likely effectively covered by the coverage area of a single serving cell. This determination allows the AP to safely instruct the modem to relax its RRM scheduling, as the likelihood of the UE moving out of the current cell's coverage is low despite the detected activity.

In another embodiment utilizing inertial sensors (e.g., accelerometer and gyroscope), the application processor may identify specific rhythmic movement patterns indicative of a user exercising. For example, the AP may detect periodic vertical acceleration signatures consistent with running on a treadmill, or step-counting patterns consistent with walking within a building. While such rhythmic movements generate Doppler shifts that might trigger a standard modem to enter a high-mobility state, the AP recognizes these patterns that do not imply a change in base stations. Consequently, the AP generates the indicator to switch the modem to the semi-static RRM scheduling state, preventing the modem from reacting aggressively to the user's local body movements.

Furthermore, the application processor may employ sensor fusion techniques, combining data from multiple sources (e.g., validating a stationary GPS position with accelerometer activity) to increase the confidence level of the motion context detection. It should be noted that the specific algorithm used by the AP to detect the motion context may vary; the present disclosure focuses on the architectural mechanism of using this AP-derived context—however obtained—to override and optimize the modem's RRM behavior.

It should be noted that the term “semi-static RRM scheduling” as used herein refers to a modified RRM behavior adopted by the modem in response to a specific motion context, wherein the modem operates with relaxed measurement parameters typical of a stationary device despite detecting physical movement. Specifically, this scheduling mode is characterized by at least one of: reducing the frequency of cell search and cell measurement operations relative to a standard high-mobility or medium-mobility state, increasing the time interval between processing Synchronization Signal Blocks (SSB) from neighboring cells, or forcing speed dependent scaling factors for reselection timers (Treselection) to unity (i.e., 1). This mode effectively overrides the modem's default mobility estimation logic—which would otherwise trigger aggressive measurement schedules based on signal fluctuations—thereby conserving power when the UE's movement is confined to a limited geographic area (e.g., a single cell coverage area).

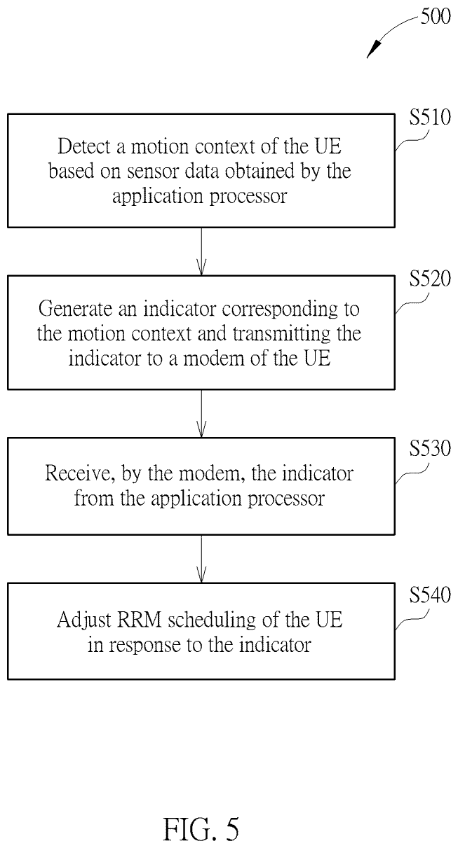

FIG. 5 depicts a flow diagram illustrating a method 500 for RRM scheduling in a UE according to an embodiment of the present disclosure. The method 500 represents a comprehensive approach to optimizing power consumption in mobile devices by intelligently coordinating sensor-based motion detection with cellular modem behavior. The method 500 can address the inefficiencies inherent in conventional RRM scheduling mechanisms that rely solely on Radio Frequency (RF) signal variations to estimate mobility states. The method 500 includes the following steps:
S510: Detect a motion context of the UE based on sensor data obtained by the application processor;
S520: Generate an indicator corresponding to the motion context and transmitting the indicator to a modem of the UE;
S530: Receive, by the modem, the indicator from the application processor; and
S540: Adjust RRM scheduling of the UE in response to the indicator.

The method 500 begins at step S510, where the application processor of the UE detects a motion context of the UE based on sensor data obtained by the application processor. This detection step represents a fundamental departure from traditional modem-only mobility estimation. The application processor, having access to a rich array of sensor inputs including but not limited to accelerometers, gyroscopes, GNSS receivers, magnetometers, barometers, and cameras, is positioned to understand the physical context of the UE's movement. In this step, the application processor analyzes the sensor data to distinguish between different types of movement patterns. For instance, the application processor may monitor GNSS coordinates over a predetermined time window to determine whether the UE exhibits significant geographic displacement or remains confined within a limited area, such as a building or gymnasium. Additionally, the application processor may analyze inertial sensor data to identify characteristic rhythmic patterns associated with specific activities, such as running on a treadmill or walking within an office environment. The application processor may employ sensor fusion techniques, combining data from multiple sensor sources to increase confidence in the detected motion context. The detection step enables the identification of “confined movement” scenarios—situations where the UE is physically active (generating signal variations that might normally trigger aggressive RRM behavior) but remains geographically stationary or confined to the coverage area of a single cell or small cluster of cells.

Following the detection of the motion context, the method proceeds to step S520, where the application processor generates an indicator corresponding to the detected motion context and transmits this indicator to the modem of the UE. The generation and transmission of this indicator represents the critical communication link between the application processor's context-awareness and the modem's RRM scheduling mechanism. The indicator serves as a signal that informs the modem about the specific motion context that has been detected, enabling the modem to adjust its behavior accordingly. In various embodiments, the indicator may be a binary signal indicating the presence or absence of a confined movement scenario, or it may be a more complex data structure containing detailed information about the detected motion context, such as confidence levels, estimated geographic boundaries, or predicted duration of the current state. The transmission of this indicator from the application processor to the modem may be accomplished through various inter-processor communication mechanisms available within the UE architecture, such as shared memory interfaces, message passing systems, or dedicated communication buses. The timing of the indicator generation and transmission may be event-driven, occurring immediately upon detection of a relevant motion context change, or it may be periodic, with the application processor continuously or regularly updating the modem with the current motion context assessment.

In step S530, the modem receives the indicator from the application processor. This reception step establishes the point at which the modem becomes aware of the application processor's motion context determination. Upon receiving the indicator, the modem validates and processes the information contained within the indicator, preparing to modify its RRM scheduling behavior accordingly. The modem may perform various checks upon receiving the indicator, such as verifying the integrity of the communication, confirming that the indicator corresponds to a recognized motion context, and determining whether the indicated context warrants a change from the current RRM scheduling state. In some embodiments, the modem may maintain a state machine that tracks the current RRM scheduling mode, and the receipt of the indicator may trigger a state transition evaluation. The modem may also implement filtering or hysteresis mechanisms to prevent excessive state transitions in response to rapidly fluctuating motion context indicators, thereby ensuring stable and efficient operation.

In step S540, the modem adjusts the RRM scheduling of the UE in response to the received indicator. This adjustment step represents the culmination of the method 500, where the context-aware information provided by the application processor is translated into concrete changes in the modem's RRM behavior. The nature of the adjustment depends on the specific motion context indicated by the received indicator. When the indicator signifies a confined movement scenario—where the UE is moving but remaining within a limited geographic area—the modem modifies its RRM scheduling to reduce unnecessary measurement activities. This adjustment may include several specific actions: reducing the frequency of Cell Search (CS) and Cell Measurement (CM) operations relative to what would normally be performed in a High-mobility or Medium-mobility state; adjusting the frequency of cell measurement operations to be equivalent to those used in a Normal-mobility state, even if RF signal variations would normally suggest a higher mobility state; setting speed dependent scaling factors to unity (i.e., 1), effectively disabling the accelerated reselection timers that would otherwise cause more frequent cell reselections; increasing the time interval between processing Synchronization Signal Blocks (SSB) received from neighboring cells; or implementing any combination of these adjustments. Conversely, when the indicator signifies that the UE has exited the confined movement context—for instance, when the user transitions from indoor exercise to vehicular travel—the modem may revert its RRM scheduling to a default measurement configuration as defined by network parameters or 3GPP specifications. This reversion ensures that the UE maintains appropriate connectivity management when truly mobile across cell boundaries. In certain embodiments, the modem may also autonomously override the application processor's indicator and revert to aggressive RRM scheduling if critical radio conditions are detected, such as the Signal-to-Noise Ratio (SNR) of the serving cell falling below a predetermined threshold, thereby ensuring that connection reliability is never compromised for the sake of power savings.

The method 500 thus provides a systematic approach to optimizing UE power consumption by enabling intelligent, context-aware RRM scheduling that accounts for the actual physical circumstances of the UE's movement, rather than relying solely on potentially misleading RF signal variations. By coordinating the capabilities of the application processor and the modem, the method achieves significant power savings in confined movement scenarios while maintaining robust connectivity management in truly mobile situations.

For clarity in this specification, certain terminological conventions are observed. The singular forms “a”, “an”, and “the” are intended to encompass plural forms as well, unless the context clearly indicates otherwise. The term “and/or” refers to and encompasses any and all possible combinations of one or more of the associated listed items. The terms “includes,” “including,” “comprises,” and “comprising” specify the presence of stated features, integers, steps, operations, elements, and/or components, but do not preclude the presence or addition of one or more other features, integers, steps, operations, elements, components, and/or groups thereof.

The term “exemplary” is used herein to mean “serving as an example, instance, or illustration” and should not be construed as necessarily preferred or advantageous over other aspects or designs.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

Terms such as “coupled,” “connected,” “connecting,” and “electrically connected” are used synonymously to describe a state of being electrically or electronically linked. When an entity is described as being in communication with another entity or entities, it implies the capability of sending and/or receiving electrical signals, which may contain image/voice or data/control information, regardless of whether these signals are analog or digital in nature.

As may be used throughout this specification and the appended claims, terms of approximation and degree such as “substantially,” “approximately,” “generally,” “essentially,” “nearly,” “about,” and similar expressions are used to account for variations in precision, manufacturing tolerances, measurement accuracy, environmental conditions, and inherent material properties that may affect the described features or characteristics. Such variations may range from ±20% in broader applications to progressively tighter tolerances of ±10%, ±5%, ±3%, ±2%, ±1%, or ±0.5% in more precise implementations. The specific degree of variation encompassed by these terms of approximation in any given context is informed by the nature of the component, relationship, or parameter being described, the technical requirements of the particular embodiment, and the understanding of one skilled in the relevant art.

In the context of this patent specification, the term “user equipment” (UE) encompasses a broad range of devices possessing radio communication capabilities. This definition includes, but is not limited to, smartphones (specifically, handheld touchscreen mobile computing devices capable of connecting to one or more cellular networks), Personal Data Assistants (PDAs), pagers, laptop computers, desktop computers, wireless handsets, and any computing device equipped with a wireless communications interface. User equipment may also be referred to by various alternative terms, including but not limited to: client, mobile device, mobile terminal, user terminal, mobile unit, mobile station, mobile user, subscriber, user, remote station, access agent, user agent, receiver, radio equipment, reconfigurable radio equipment, or reconfigurable mobile device. These terms should be considered interchangeable within the context of this document.

The scope of UEs also extends to Internet of Things (IoT) devices. IoT UEs are characterized by a network access layer specifically designed for low-power IoT applications that typically involve short-lived UE connections. These IoT UEs may employ various technologies for data exchange, including Machine-to-Machine (M2M), Machine Type Communication (MTC), or massive MTC (mMTC). Such data exchanges may occur with an MTC server or device via a Public Land Mobile Network (PLMN), with other UEs using Proximity Services (ProSe) or Device-to-Device (D2D) communications, or through sensor networks or IoT networks. It is noteworthy that M2M or MTC data exchanges are often initiated by the machine itself rather than by human intervention.

An IoT network, as referenced in the above section, describes an interconnected system of IoT UEs. These UEs may include uniquely identifiable embedded computing devices integrated within the broader Internet infrastructure. IoT UEs may execute background applications, such as keep-alive messages or status updates, to maintain and facilitate the connections within the IoT network.

UEs are configured to establish communicative coupling with Radio Access Networks (RANs) through a radio interface. This radio interface is a physical communication interface or layer designed to operate with various cellular communication protocols. These protocols may include, but are not limited to, Global System for Mobile Communications (GSM) protocol, Code Division Multiple Access (CDMA) network protocol, Push-to-Talk (PTT) protocol, PTT over Cellular (POC) protocol, Universal Mobile Telecommunications System (UMTS) protocol, 3rd Generation Partnership Project Long-Term Evolution (3GPP LTE) protocol, 5G protocol, and New Radio (NR) protocol.

As a specific example, a UE and a RAN may utilize a Uu interface (such as an LTE-Uu interface) to exchange control plane data. This exchange occurs via a protocol stack comprising multiple layers: a Physical (PHY) layer, a Medium Access Control (MAC) layer, a Radio Link Control (RLC) layer, a Packet Data Convergence Protocol (PDCP) layer, and a Radio Resource Control (RRC) layer. In this context, a Downlink (DL) transmission refers to data sent from the RAN to the UE, while an Uplink (UL) transmission refers to data sent from the UE to the RAN.

Furthermore, UEs may employ a sidelink for direct communication with other UEs, facilitating D2D, Peer-to-Peer (P2P), and/or ProSe communication. A ProSe interface, for instance, may incorporate one or more logical channels. These channels include, but are not limited to, a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The various aspects described herein may be implemented using a variety of hardware and software components. These may include processors, Digital Signal Processors (DSPs), Application Specific Integrated Circuits (ASICs), Field Programmable Gate Arrays (FPGAs) or other programmable logic devices, discrete gates or transistor logic, or discrete hardware components. A processor in this context may be a microprocessor, but could also be any conventional processor, controller, microcontroller, or state machine. Processors may also be implemented as combinations of computing devices, such as a combination of a DSP and a microprocessor, multiple microprocessors, one or more microprocessors in conjunction with a DSP core, or any other such configuration.

The aspects described in this specification can be implemented through both hardware and software instructions. These instructions may be stored on various types of computer-readable media, including but not limited to Random Access Memory (RAM), flash memory, Read Only Memory (ROM), Electrically Programmable ROM (EPROM), Electrically Erasable Programmable ROM (EEPROM), registers, hard disks, removable disks, CD-ROMs, or any other form of storage medium known in the art. In a typical configuration, the storage medium is connected to a processor, enabling the processor to read information from and write information to the medium. In some configurations, the storage medium may be integral to the processor itself.

Some embodiments may involve computers on a distributed computing network, such as a network with multiple clients and/or servers. In such embodiments, clients may run software implementing client-side portions of the described systems and methods, while servers handle requests from these clients. Communication between clients and servers may occur via one or more electronic networks, which may include the Internet, wide area networks, mobile telephone networks, wireless networks (e.g., Wi-Fi, 5G), or local area networks, implemented using any known network protocols.

In implementations where the systems described in this specification collect user information, provisions may be made to protect user privacy and data. Specifically, users may be afforded the opportunity to opt in or out of programs or features that collect personal information, such as data related to user preferences or smart device usage patterns. Furthermore, in certain embodiments, data protection measures may be implemented to anonymize collected information prior to storage or utilization. For instance, a user's identity may be anonymized to prevent the determination or association of personally identifiable information with that specific user. Additionally, user preferences and interaction data may be generalized, potentially based on broader demographic categories, rather than being linked to individual users.

It should be noted that the operational steps described in any exemplary aspects within this specification are provided as examples and for discussion purposes. These operations may be performed in numerous different sequences other than the illustrated sequences. Furthermore, operations described in a single step may actually be performed as multiple distinct steps, and multiple steps may be combined into a single operational step. The steps in the appended figures may be subject to numerous modifications as will be apparent to those skilled in the art.

Some embodiments may incorporate all explicitly disclosed features as well as additional features that, while not specifically described herein, are compatible with and enhance the core invention. Conversely, other embodiments may selectively omit certain non-disclosed elements, either partially or in their entirety, while still falling within the scope of the invention. This flexibility in feature inclusion or exclusion allows for a range of implementations tailored to specific applications or requirements, without departing from the fundamental principles of the invention.

The logical stages illustrated in the drawings may be reordered, combined, or broken out if they are not order-dependent. The ordering and groupings presented in this specification are not exhaustive, and other arrangements will be apparent to those skilled in the art. These stages may be implemented in hardware, firmware, software, or any combination thereof.

The drawings and descriptions provided in this specification offer detailed illustrations of various embodiments of the invention. However, it should be understood by those skilled in the art that these embodiments can be implemented without necessarily adhering to every specific detail provided herein. In some instances, well-established methods, procedures, components, and circuits have been mentioned without elaborate explanations to avoid obscuring the key aspects of the embodiments. It is important to note that the figures presented in this specification, including any component diagrams, are intended for illustrative purposes and may not be drawn to scale. This allows for a clear presentation of the inventive concepts while leaving room for variations and adaptations within the scope of the invention.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A method for Radio Resource Management (RRM) scheduling in a user equipment (UE), the method comprising:
detecting, by an application processor of the UE, a motion context of the UE based on sensor data obtained by the application processor;
generating, by the application processor, an indicator corresponding to the motion context and transmitting the indicator to a modem of the UE;
receiving, by the modem, the indicator from the application processor; and
adjusting, by the modem, RRM scheduling of the UE in response to the indicator.

2. The method of claim 1, wherein the motion context indicates a movement of the UE limited to a confined geographic area.

3. The method of claim 1, wherein adjusting the RRM scheduling comprises reducing a frequency of a cell measurement operation relative to a High-mobility state or a Medium-mobility state.

4. The method of claim 1, wherein adjusting the RRM scheduling comprises adjusting a frequency of a cell measurement operation equivalent to a Normal-mobility state.

5. The method of claim 1, wherein adjusting the RRM scheduling comprises adjusting a speed dependent scaling to unity such that a cell reselection frequency is lower than a frequency associated with a high-mobility state.

6. The method of claim 1, wherein the sensor data is obtained from at least one of: an accelerometer, a gyroscope, a Global Navigation Satellite System (GNSS) receiver, and a camera of the UE.

7. The method of claim 1, further comprising:
detecting, by the application processor, that the UE has exited the motion context;
transmitting a second indicator to the modem; and
reverting, by the modem, the RRM scheduling to a default measurement configuration defined by a network parameter in response to the second indicator.

8. The method of claim 1, wherein adjusting the RRM scheduling comprises reducing a frequency of processing Synchronization Signal Blocks (SSB) received from neighboring cells.

9. A user equipment (UE), comprising:
an application processor, configured to:
detect a motion context of the UE based on sensor data; and
generate an indicator corresponding to the motion context;
a modem coupled to the application processor, and configured to:
receive the indicator from the application processor; and
adjust an RRM scheduling of the UE in response to the indicator.

10. The UE of claim 9, wherein the motion context indicates a movement of the UE limited to a confined geographic area.

11. The UE of claim 9, wherein the modem is configured to adjust the RRM scheduling by reducing a frequency of a cell measurement operation relative to a High-mobility state or a Medium-mobility state.

12. The UE of claim 9, wherein the modem is configured to adjust the RRM scheduling by adjusting a frequency of a cell measurement operation equivalent to a Normal-mobility state.

13. The UE of claim 9, wherein the modem is configured to adjust the RRM scheduling by adjusting a speed dependent scaling to unity such that a cell reselection frequency is lower than a frequency associated with a high-mobility state.

14. The UE of claim 9, further comprising at least one sensor coupled to the application processor, wherein the at least one sensor comprises: an accelerometer, a gyroscope, a Global Navigation Satellite System (GNSS) receiver, or a camera.

15. The UE of claim 9, wherein:
the application processor is further configured to detect that the UE has exited the motion context and transmit a second indicator to the modem; and
the modem is further configured to revert the RRM scheduling to a default measurement configuration defined by a network parameter in response to the second indicator.

16. The UE of claim 9, wherein the modem is further configured to adjust the RRM scheduling by reducing a frequency of processing Synchronization Signal Blocks (SSB) received from neighboring cells.
